(19) United States
(12) Patent Application Publication
(10) Pub. No.: US 2015/0121313 A1
(43) Pub. Date: Apr. 30, 2015

(54) Method for navigating among a multitude of displayable data entities arranged in a hierarchy, a wearable device and a computer program product

(71) Applicant: Korulab Inc., Espoo (FI)

(72) Inventors: Christian Lindholm, Espoo (FI); Terho Niemi, Espoo (FI); Sebastien Gianelli, Espoo (FI)

(73) Assignee: Korulab Inc., Espoo (FI)

(21) Appl. No.: 14/064,216

(22) Filed: Oct. 28, 2013

(51) Int. Cl. G06F 3/0482; G06F 3/0484

(52) U.S. Cl. CPC G06F 3/0482; G06F 3/04845
USPC 715/854

(57) ABSTRACT

The present invention relates to navigation methods and computer programs for wearable devices and a wearable device, for enabling a user to navigate among a multitude of data entities to be displayed on a relatively small viewing area of a touch-sensitive display screen. The inventive concept includes:
defining a viewing area visible to the user on the touch-sensitive display means for displaying information on at least one first level of the hierarchy;
sensing the position of the device with regard to the user to keep the viewing area on the touch-sensitive display means visible to the user;
defining at least one area of the touch-sensitive display means that is outside said viewing area as at least one command entry area;
upon sensing at least one press by the user on the command entry area, a predetermined command is issued that changes the displayed information in the viewing area by navigating to a second level in the hierarchy of data entities that is different from the first level.

### FIELD OF THE INVENTION

The present invention relates to navigation methods and computer programs for wearable devices and a wearable device. More specifically, the invention relates to a method and a computer program product for enabling a user to navigate among a multitude of data entities to be displayed on a relatively small viewing area of a touch-sensitive display screen.

### BACKGROUND OF THE INVENTION

Mobile devices have developed through integration of several previously separate digital devices into today's versatile mobile smartphones and tablet computers having a multitude of capabilities. While being extremely useful and powerful, these devices are usually fairly large due to the demand for large displays to show internet, live video and game content. The displays have also become interactive, meaning many users are touching and peeking on the surface of the display in public places in a way not seen before. As the use of mobile devices continues to increase, e.g. smartphone use as social distraction has become apparent.

Content-intensive information processing and entertainment drive the mobile device displays size to increase, and the bulk factor of mobile devices is already considerable. Sorts and free-time activities limits the ability to handle a large, expensive and fragile smartphones, despite accessories like shock protective, carrying and waterproof casings.

However, most everyday basic interactions do not require the use of a large touchscreen of mobile devices. Also, large and generic mobile devices are not integral enough for controlling a personal area network (PAN) used e.g. in smart clothes, sports appliances, etc. A common problem is how to introduce back-step (escape) and exit buttons on very small displays, as used in for wearable devices. Another problem is as the screen shrinks and the fingers remain of constant size, how to manage scrolling without covering the display.

There is a need for a wearable device that will accommodate selecting and browsing by tapping and sweeping on the display as known from larger touchscreen devices, but also provides a smart and selective navigation system and means to deal with digital information in daily life also on small displays. Such a device should also offer a better alternative to a large smartphone for basic functions like messaging and timekeeping, to communicate with other devices like sensors and wireless devices, and for various controlling tasks e.g. at home. If the wearable device also provides a wireless internet connection, the amount of different tasks such a device can deal with is unlimited.

### BACKGROUND ART

It is however with a display of 5 cm or less as in a watch or armband display, very difficult to achieve smooth and accurate operation and user satisfaction. Many approaches to the problem is known from the literature, but the lack of successful products on the market signals that solutions that would gain consumer acceptance are yet to be found. U.S. Pat. No. 8,098,141 discloses a touch sensitive wearable band with a touch sensing circuit and an electronic device configured to receive signals generated from the touch sensing circuit to provide to provide an indication or a function for a user of the wearable band. A recent development may be seen in US Patent Application 2013/0271495, where a wearable accessory with a multi-segment display is envisaged, where the content of each display segment may change according to the position of the accessory. Navigation between the segments is also provided in order to shift information from one segment to another, and to take into use more than one display segment for a dedicated application. The navigation is however restricted to the interplay between displayed information on the segments by touching neighboring segments to issue various flows of the information being displayed.

### SUMMARY OF THE INVENTION

The present invention aims to take the art of wearable computing a leap forward, by offering a novel method, computer program product and device for navigating with small display screens. A fundamental part of the invention is the user interface and its ability to handle and display information on a small display, or a display that is not completely visible to the user. The inventive navigation system is easy and intuitive to learn, and offers ambiguity in the use and operation of a wearable computer having a relatively small display screen.

The invention is characterized by what is stated in the appended claims. Provided is an inventive method for navigating among a multitude of displayable data entities arranged in a hierarchy in a device having touch-sensitive display means. The inventive method includes the steps of:
defining a viewing area visible to the user on said touch-sensitive display means for displaying information on at least one first level of said hierarchy;
sensing the position of the device with regard to the user to keep the viewing area on the touch-sensitive display means visible to the user;
defining at least one area of the touch-sensitive display means that is outside the viewing area as at least one command entry area;
upon sensing at least one press by the user on at least one command entry area, issuing a predetermined command changing the displayed information in the viewing area by navigating to a second level in said hierarchy of data entities that is different from said first level.

With the concepts “touch sensitive” of the display and “touch screen” mentioned and used throughout the description and claims, it is not the intention to restrict the inventive method and device to a particular touch sensitivity technology. The present invention is fully functioning also on related recently emerging technologies that allow the user wearing a glove or the like, while the touch screen still senses taps, gestures and swipes made over the screen. Likewise, the capacitive sensing field of a touch screen display may also extend to a distance above the display surface, whereby the device can be commanded by e.g. hovering with a finger over the display at appropriate icons or commando input buttons, as well as doing a swipe over but at a distance from the display.

In one preferred embodiment of the inventive method, the viewing area of the touch-sensitive display means is created dynamically by sliding the viewing area along an elongate display means as determined by orientation means sensing the position of the device with regard to the user and configuring at least one display area not in the current viewing area as a command entry area. The sensing of the position of the device to keep the viewing area in line of sight of the user may be done by an orientation sensor in the device carried on the user's wrist by sensing the current rotational position of the wrist.

According to an alternative preferred embodiment of the inventive method the touch-sensitive display means includes at least two discrete display screens on different sides of the device, and the method includes the step of dynamically configuring the display screen being on a side which is in the line of sight of the user as the current viewing area, and the display screens being on any other side as at least one command entry area. The sensing of the position of the device to keep the viewing area in line of sight of the user may be done by an orientation sensor in the device carried in the hand of the user wrist by sensing the current display screen being faced upward.

When a device according to the present invention is being used, a press by the user on at least one command entry area may issue a command that is stepping the displayed information in said viewing area to the next higher level of said hierarchy of data entities. Two simultaneous presses by the user on two different command entry areas issues an exit command will take the displayed information to the highest level of said hierarchy of data entities.

In a further embodiment of the invention, a press by the user on at least one additional area outside the display screen is sensed with at least one sensing element, in order to issue a command to alter the displayed information in said viewing area within the same level of said hierarchy of data entities.

In still an embodiment, two simultaneous presses by the user on two selected additional areas outside and on opposite sides of the display screen having a multitude of sensing elements, may issue a select command to select the data entity located on a virtual line crossing the display screen between said selected areas, and then a command to alter the selected data entity may be issued.

The invention relates also to computer program product comprising at least one computer-readable storage medium having computer-executable program code portions stored therein. The computer-executable program code portions comprises program code instructions for providing navigation among a multitude of displayable data entities arranged in a hierarchy, as explained above.

The invention also concerns a wearable device having a casing with touch-sensitive display means, said device comprising:
first sensing means for sensing the position of the device with regard to a line-of-sight to the user,
processing means responsive to the first sensing means and for displaying data from a hierarchy of displayable data entities on a viewing area of said display means that is kept in line-of-sight of the user; the processing means being further configured to define at least one area of the touch-sensitive display means that is outside said viewing area as at least one command entry area. Furthermore it senses and interprets at least one press by the user on said at least one command entry area as a predetermined navigation command to change the displayed information in said viewing area to another level in said hierarchy of data entities.

According to a preferred embodiment, the wearable device includes an elongate display and is arranged to be carried on the user's wrist. The first sensing means is an orientation sensor sensing the current rotational position of the wrist to keep the viewing area in line-of-sight of the user. The processing means is adapted to dynamically create the viewing area on the elongate display by sliding the viewing area on the display in response to orientation signals provided by the first sensing means. Areas of the display not in the current viewing area are configured as at least one command entry area.

According to an alternative embodiment, the wearable device includes at least two discrete display screens on different sides of said wearable device, and the first sensing means is an orientation sensor sensing the current display screen being faced upward in line-of-sight of the user when carried in the hand of the user, whereby the processing means is adapted to dynamically create the viewing area on the upwardly oriented display screen in response to orientation signals provided by the first sensing means, and to configure display screens being on any other side as at least one command entry area. The first sensing means may be selected from a group of devices like a gyroscope, a gravity switch, one or more accelerometers, a light sensor, a camera, or any combination thereof.

According to one embodiment, the wearable device includes a second sensing means located at least one additional area outside the display screen, wherein the processing means is configured to sense and interpret at least one press by the user on the second sensing means as a navigation command to alter the displayed information in the viewing area within the same level of said hierarchy of data entities.

The inventive wearable device may include a multitude of second sensing means arranged in a row on opposite sides and outside of the display screen, wherein the processing means is configured to sense and interpret two simultaneous presses by the user on two selected second sensing means outside and on opposite sides of the display screen as a select command to select the data entity located on a virtual line crossing the display screen between the selected sensing means. The processing means will then issue a command to alter the selected data entity.

In the following, the various embodiments of the invention is described in more detail by means of examples and by referring to the attached drawings, wherein

### BRIEF DESCRIPTION OF THE DRAWINGS

FIG. 1 shows a schematic view of a first embodiment of the invention;

FIGS. 2a-2b shows a functionality of the embodiment shown in FIG. 1;

FIGS. 3a-3b shows a schematic view of another embodiment of the invention;

FIGS. 4a-4b shows a further functionality of the inventive device;

FIG. 5 shows an example of the user interface functionality in the present invention;

FIG. 6 shows a block diagram of the software structure of the inventive device.

### DETAILED DESCRIPTION OF EMBODIMENTS

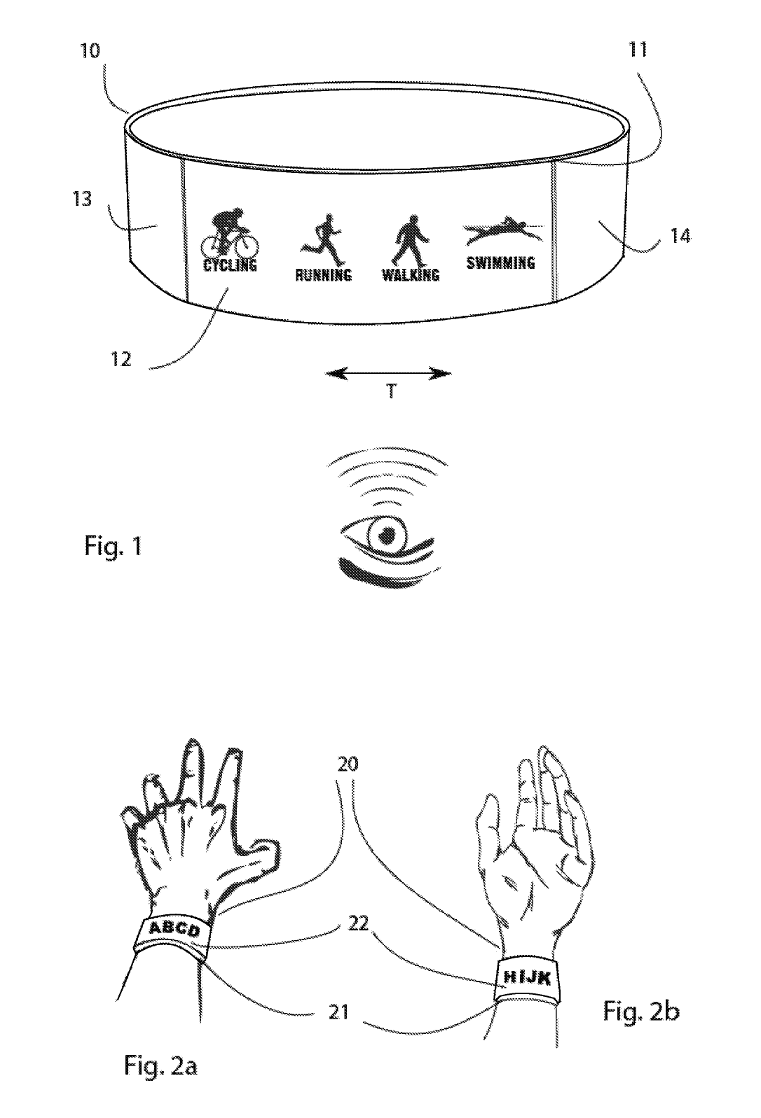

Referring now to FIG. 1, an armband or bracelet-like device 10 is shown, having a display screen 11 of a flexible material, for example a touch-sensitive AMOLED display, reaching essentially around the outer circumference of the whole armband 10. A viewing area 12 is showing information to the user on the display. The viewing area is only of the size that can be seen by the user in the current position he or she is keeping the armband. In practice this means around 120 degrees out of the full armband of 360 degrees, when represented as the angle of a full circle. Areas 13 and 14 on the display are part of the same display, but are darkened and configured as command entry areas, i.e. buttons. According to the invention, the active viewing area as visible to the user is calculated in response to signals from an orientation sensor like a gyroscope or accelerometer, or a combination thereof. The device may have several states, including a turned-off state, a passive state (showing e.g. the time and date only), an active select state (for browsing for and selection of an application or data entity), and active manipulate state, for running an application, reading content or editing.

The activation of the device from a higher (more passive) state can be done by a sweep over the display with a finger. Generally, the navigation system is based on the user scrolling horizontally (along the armband's display) between the main options of the data entities of a certain level of the information hierarchy. 2D-navigation is provided by a vertical sweep across the display perpendicularly to the horizontal sweep, whereby the sub-options of the same information entity main option are browsed through. Activation of an application, or opening a hypertext link etc. is done by tapping on the display, from one up to say three times, depending on the application and the alternate actions offered by activation.

This invention introduces the concept of overscroll in wearable devices, which means displaying items/content information on a viewing area being a smaller portion of a larger display, and scrolling the information in the viewing area in response to a sensed position or change of position of the wearable device. The length of the viewing area 12 may be scaled to be proportional to the perimeter of the user's wrist, as it by humans can vary between 9-25 cm. This is to make sure the length of the effective display 12 is not larger than the viewing area of the user. The display areas 13 and 14 outside the viewing area 12 are configured as command entry areas or buttons that are used for back-stepping and exit functions. According to the invention, the viewing area is ‘floating on the larger display, and the areas outside the viewing area can then be used for overscrolling and back-stepping functions.

A user is normally capable of turning his left wrist from its resting position about 90-180 degrees counterclockwise and about 20 degrees clockwise. The same applies vice versa for the right wrist. According to the present invention, the viewing area 12 will upon a turn of the wrist overscroll or “float” on the armband's display 11 in either direction T depending on how the wrist is turned. The viewing area will then show information that has been so far concealed. For example, if a fifth sports discipline “riding” would be available but concealed under the area 14 in FIG. 1, it would by turning the armband of FIG. 2 counterclockwise i.e. in the left direction of arrow T emerge to be visible from the area 14 now escaping to the right, as the viewing area 12 scrolls to the right. This causes the now visible “cycling” alternative to disappear under the area 13 growing from left. In this way, the user can bring the content of a display reaching almost around the whole wrist into his line of sight, as illustrated by the eye in FIG. 1, by merely turning his wrist. The approximate viewing angle, being some 100-120 degrees on a conventional display with no overscroll function, is then greatly enhanced to at least 210 degrees up to a full 360 degrees, depending on the individual.

The information on the display can then be scrolled back and forth on the viewing area of the display by sweeping with a fingertip along the viewing area 12 of the display, an enter or execution command can be issued by tapping once, twice or thrice, depending on the desired functionality of the software, on the relevant symbol on the area 12.

If the user wants to issue a command stepping the displayed information in the viewing area to the next higher level of the hierarchy of data entities, he may issue a back-step command by simply tapping on the command area button 13 or 14. If the user wants to issue an exit command taking the device to the highest level of the hierarchy of data entities, like a “home” page display or a passive standby, it may be issued by pressing at both buttons 13 and 14 simultaneously, e.g. with the thumb and the forefinger. However, these are only examples, as equally well two fingers may be used for two back-steps, and also tap and double-tap on the command area buttons may be used for making the navigation commands more versatile. The main object of the invention is to define at least one area of a touch-sensitive display as a command entry area and upon sensing at least one press by the user on such an area, to issue a command that will change the displayed information to another level in said hierarchy of data entities that is different from the present level.

FIGS. 2a and 2b shows the overscroll feature when the wrist 20 is turned from the position in FIG. 2a 180 degrees counterclockwise to the position in FIG. 2b. The armband 21 is showing the alphabet letters, and from the initial position in FIG. 2a showing the letters A . . . D it shows the letters H . . . K in FIG. 2b. Further scrolling by a fingertip sweep over the display's viewing area 22 will then reveal the end of the alphabet. This exemplifies further how the viewing area 22 is dynamically moving as the user turns his wrist 20.

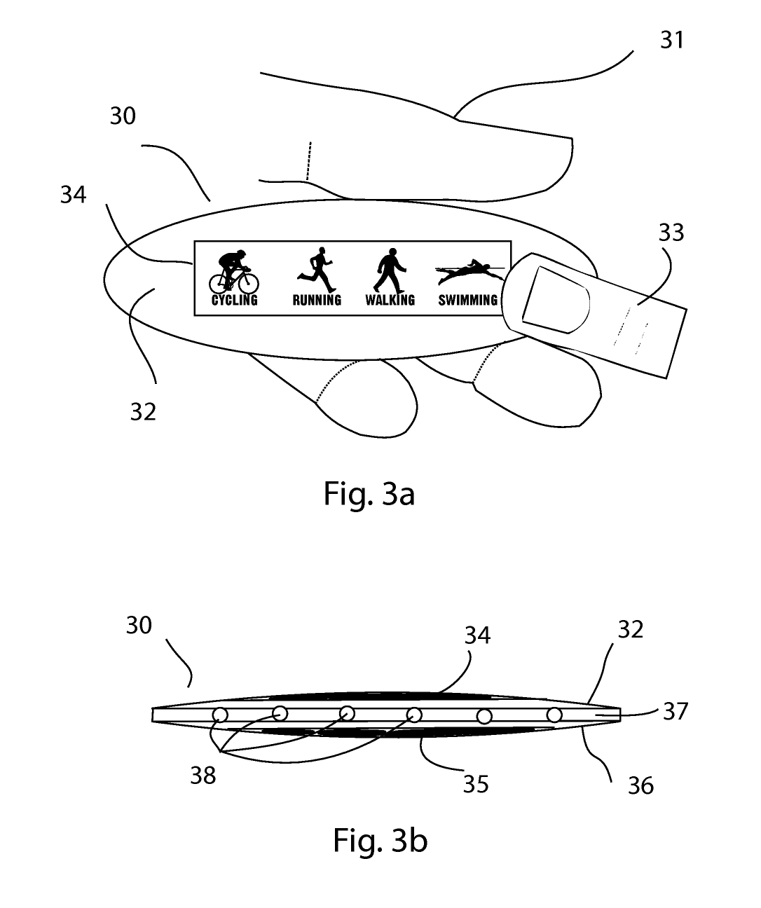

In FIGS. 3a and 3b is shown another embodiment of the inventive wearable device, where the device is shaped as an amulet or pendant 30. Here, the device has two discrete display screens 34 and 35 on each side 32 and 36 of the device 30. Each of the displays can be scrolled horizontally and vertically by using a fingertip 33 as has been explained in connection with FIG. 1. Here, the sensing means is an orientation sensor (not shown), like a gravity switch or a gyroscope, that senses the current display 34 that is in the hand 31 of the user being faced upward, i.e. in line-of-sight of the user. In the position shown, the touch-sensitive display 35 is configured to be used as the command entry area or button. If the device is flipped upside down, display 35 will show more information relating to the same level of hierarchy before the flip, and display 34 is set to be the command entry area.

If the user wants to issue a command stepping the displayed information in the viewing area to the next higher level of the hierarchy of data entities, he may issue a back-step command by simply tapping once on the display 34 or 35 being faced downward. If the user wants to issue an exit command taking the device to the highest level of the hierarchy of data entities, like a “home” page display or a passive standby, it may be issued by tapping twice in a repetitive fashion on the display 34 or 35 being faced downward at that moment.

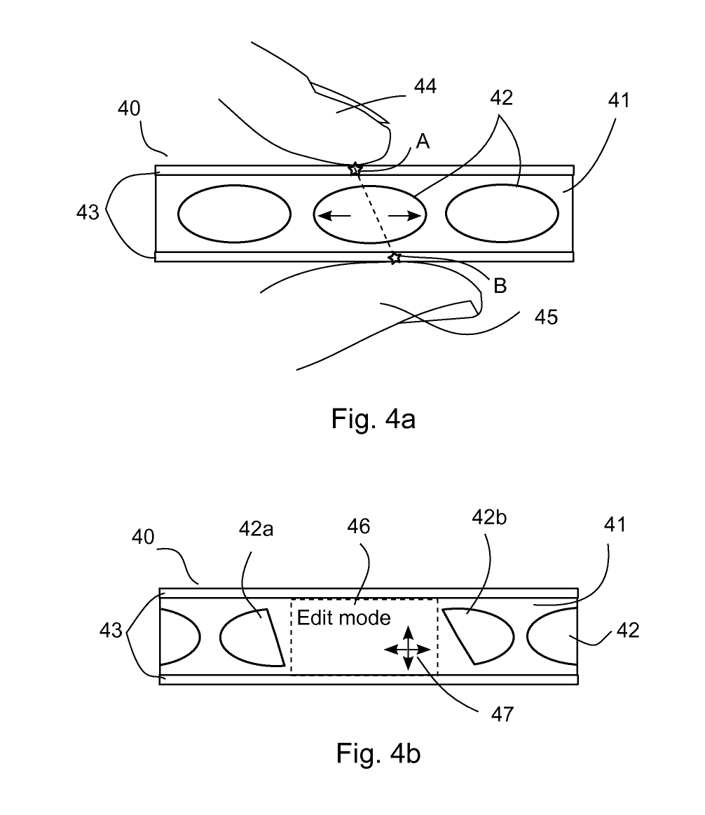

The edge 37 of the casing of the wearable device 30 is in one preferred embodiment of the invention provided with a plurality of second sensing means, i.e. sensors 38 arranged in a line. These sensors, especially if there are only a few of them, may be used in a conventional fashion ad power-off or home buttons, shortcuts, for functions like mode select, etc. However, the operation of the sensors 38 as arranged on both sides or around the wearable device is described in detail in connection with FIGS. 4a and 4b.

In FIG. 4a is shown a section, i.e. the current viewing area of an inventive armband wearable device 40 like the one in FIG. 1. The user keeps the armband between his forefinger 44 and thumb 45, pressing it slightly from the sides of the display 41 at points A and B, respectively. The display 41 is currently showing three data entities 42, and the user wants to edit information related to the one in the middle. If it would be an icon representing the contact information for a person, for example, this feature would be used to edit, add or delete a telephone number. Another example is if the user taps on a weather icon, he would see more weather information related to his present or the selected location. If he presses the device from opposite sides as shown, he would enter e.g. a list of cities so select from, with an option to add cities and edit the list.

The wearable device 41 has side panels 43 along the full length of the display 31. These panels contain second sensing means or sensors 38 as shown in FIG. 3b arranged in a similar manner in a line along both sides of the display. Two of these sensors are at points A and B in FIG. 4a, and they create a virtual dotted line as shown. The processor of the wearable device is configured to sense and interpret such two simultaneous presses by the user on two spots A and B, in order to identify which one of the data entities 42 the user want to access for editing or changing. It is to be noted that a mere view of the information content, or running an application, should the icon 42 represent such, would only need a tap or two on the icon itself. Here the user wants to alter information. When the data entity is identified, the halves 42a and 42b along with the rest of the display content start to move in opposite directions, as indicated by arrows in FIG. 4a and shown as completed in FIG. 4b. A new “edit mode” window 46 is opened, allowing for 2D-scrolling 47 to seek and find the data element (not shown) to be manipulated. In the sense of the meaning and terminology used in this context, the sensor panels 43 constitute, in addition to the command entry areas of the display, a second sensing means for issuing navigation commands to alter displayed information in the viewing area within the same level of said hierarchy of data entities.

The data manipulation itself can be done in many ways, and is not part of the present invention. For example, all available parameters or options can be listed in the window 46 and the correct one only need to be selected. Also traffic filter parameters may be set here to avoid distraction of trivial notifications in social media, for example. A robust and highly personal layer of abstraction in the menus help to minimize laborous user input and keep interaction options relevant. However, for alphanumeric input, a variety of character selecting methods exist that are suitable for small displays. In this context, a scrolling alphabet like the one shown in FIGS. 2a and 2b may prove useful. The correct character or number is then selected by tapping on it. Alternatively, the wearable device may have a wireless connection to an external device, like a smartphone. The device may also be part of a wireless Personal Area Network (PAN). In such a case, all more elaborate editing may be done outside the wearable device and transferred via a bluetooth or wlan link or any other suitable wireless technology to the wearable device. The more simple parametrization tasks may then be performed as described above, by scrolling and selecting from menus and lists.

Other smartphone-related useful features that may be present as applications in the inventive wearable device include smartphone proximity (and finding) detection, caller identification without having to look at the phone, and remote profile setting for the phone. A wearable device like the inventive one has a lower user activation threshold than a smartphone or a tablet computer, as it allows the user to to check and respond to events discreetly. In this way, fetching and opening the larger device in an interruptive way is not necessary that often anymore.

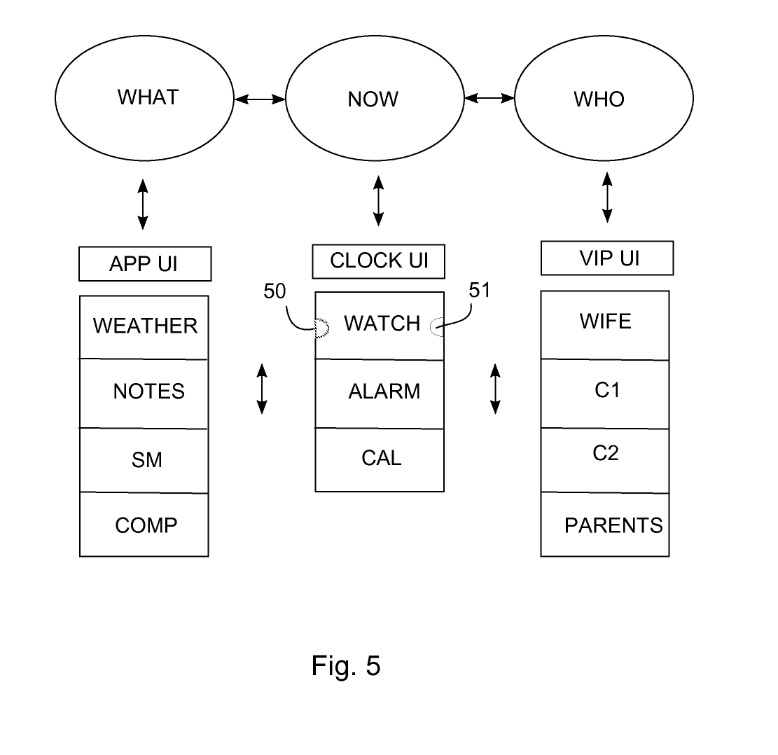

Turning now to FIG. 5, where an example of the overall user interface and browsing logic is shown. On top the three core views of the user interface system are depicted, the “WHAT”, “NOW and “WHO” views. They can be scrolled to the left or to the right in a horizontal manner, as indicated by the horizontal arrows between them. As can be easily understood from FIG. 5, the WHAT core view collects under its umbrella APP UI applications of various kinds with a specific purpose and content. Listed as examples only are weather, notes, social media (SM) and a compass (COMP). Other options may include fitness applications and hardware status information with device capabilities and battery power indication.

By tapping once on the WHAT icon it becomes activated and the content under it can be scrolled vertically, as indicated by the vertical arrows. Some of these data entities are local to the wearable device or resides within the PAN of the user, others are using web-based services and may therefore be seen as widgets. Similarly, the NOW core view offers a CLOCK UI with a watch, an alarm clock and a calendar application, in which easily may be included further time-dependent functions like calendar reminders etc. Finally, the WHO core view can be scrolled with the aid of the VIP UI for contact information and personal messaging to family members and friends, shown are only by example the wife, children (C1 and C2) and the parents. Also a complete personal phonebook and contact backup may be included.

A widget is a web-based on-screen device such as a clock, a daily weather indicator, or an event countdown, or they can be used for transferring personal messages, like icons indicative of mood, feelings etc., from one device to another via a web-based service. It is clear to one skilled in the art that connections to the internet are radially available for also small devices, either directly by wlan or a cellular network, or via smartphone or computer using a bluetooth link or other internet sharing technologies, like using a smartphone connected to a cellular network as a wlan base station.

It is also easily appreciated from FIG. 5 that the user interface may include the possibility to detect social media or family messaging updates in whatever state the user is in. For example, if the user is having the wearable device in a standby mode under the CLOCK UI and merely showing the time of the day, a small icon 50 and/or 51 can be displayed on the display. The icon 50 appearing to the left would suggest there is an update in one of the applications under the APP UI, and the icon 51 appearing to the right would suggest an update to the right in the contacts under the VIP UI. The icons 50 and 51 may carry more specific information about the update having a specific color, symbol or character included. A social media update or a message from a child would then easily be noted by the user. It is also possible to assign an icon to a specific person, and also to assign types of messages to this kind of icons, so that e.g. a fast blinking red icon on the display would mean some kind of panic.

In order to see the update, there is no need to back out from the NOW core view to the top level and then go down by the correct core view. It would be enough to do a horizontal sweep towards the icon is on the display, and the user interface system would then create a shortcut to the updated item and show it on the display.

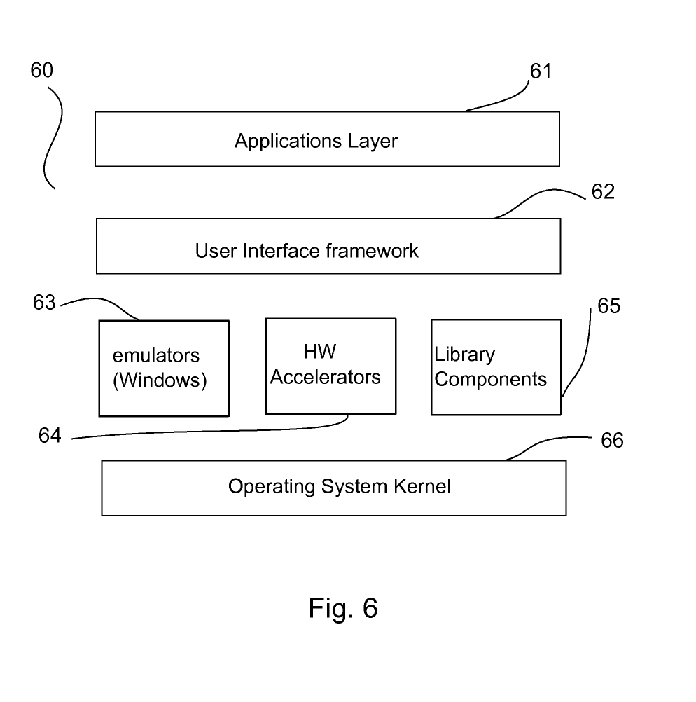

In FIG. 6, a block diagram of the software structure 60 of the inventive device is shown. The uppermost block is the Applications Layer block 61, which contain the software for the various utilities the user has decided to download and purchase with the wearable device. Obviously, not all applications need to be purchased separately, but are included in the device when sold. Block 62 is the User Interface Framework, where the user interface for the wearable device is defined. Many functionalities of the present invention reside here, and it includes e.g. an application programming interface (API), a user interface widget library, an XML/SVG scalable vector graphics engine, and an operating system adaptation API.

Block 63 is for any optional operating system like Windows, if for example applications need to be run that are native to another operating system than the one contained in the wearable device. Block 64 contains hardware accelerators, which may often be needed in low-power processor systems. Block 65 is an optional software library containing drivers, external interfaces and other components that may be needed for selected configurations of the device. Finally, block 66 contains the operating system of the device, which in preferred embodiments of the invention are NetBSD or Linux-based.

The processor needed to power the wearable device and constituting with the software structure the processing means needed to implement the invention, may be selected from a range of low-power microcontrollers like ARM Cortex-M4 to powerful processors like ARM Cortex-A9.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural data elements or menus may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of features, user interface details, shapes, etc., to provide a thorough understanding of embodiments of the invention. One skilled in the relevant art will recognize, however, that the invention can be practiced without one or more of the specific details, or with other methods and components etc. In other instances, well-known structures, materials, or operations are not shown or described in detail to avoid obscuring aspects of the invention. While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for navigating among a multitude of displayable data entities arranged in a hierarchy in a device having touch-sensitive display, wherein the method includes the steps of:
defining a viewing area visible to the user on said touch-sensitive display for displaying information on at least one first level of said hierarchy;
sensing the position of the device with regard to the user to keep the viewing area on said touch-sensitive display visible to the user;
defining at least one area of said touch-sensitive display that is outside said viewing area as at least one command entry area; and
upon sensing at least one press by the user on said at least one command entry area, issuing a predetermined command changing the displayed information in said viewing area by navigating to a second level in said hierarchy of data entities that is different from said first level.

2. A method according to claim 1, wherein the viewing area of the touch-sensitive display is created dynamically by sliding said viewing area along an elongate display as determined by an orientation sensor sensing the position of the device with regard to the user and configuring at least one display area not in the current viewing area as a command entry area.

3. A method according to claim 1, wherein the touch-sensitive display includes at least two discrete display screens on different sides of said device, the method including the step of dynamically configuring the display screen being on a side which is in the line of sight of the user as the current viewing area, and the display screens being on any other side as at least one command entry area.

4. A method according to claim 2, wherein the sensing of the position of the device to keep the viewing area in line of sight of the user is done by the orientation sensor in said device carried on the user's wrist by sensing the current rotational position of the wrist.

5. A method according to claim 3, wherein the sensing of the position of the device to keep the viewing area in line of sight of the user is done by the orientation sensor in said device carried in the hand of the user by sensing the current display screen being faced upward.

6. A method according to claim 1, wherein a press by the user on at least one command entry area issues a command stepping the displayed information in said viewing area to the next higher level of said hierarchy of data entities.

7. A method according to claim 1, wherein two simultaneous presses by the user on two different command entry areas issues an exit command taking the displayed information to the highest level of said hierarchy of data entities.

8. A method according to claim 1, wherein a press by the user on at least one additional area outside the display screen is sensed with at least one sensing element in order to issue a command to alter the displayed information in said viewing area within the same level of said hierarchy of data entities.

9. A method according to claim 8, wherein two simultaneous presses by the user on two selected additional areas outside and on opposite sides of the display screen having a multitude of sensing elements issues a select command to select the data entity located on a virtual line crossing the display screen between said selected areas, and issues a command to alter the selected data entity.

10. A wearable device having a casing with touch-sensitive display, said device comprising:
a first sensor for sensing the position of the device with regard to a line-of-sight to the user, and
a processor responsive to said first sensor and for displaying data from a hierarchy of displayable data entities on a viewing area of said display that is kept in line-of-sight of the user; said processor being further configured to define at least one area of said touch-sensitive display that is outside said viewing area as at least one command entry area, and to sense and interpret at least one press by the user on said at least one command entry area as a predetermined navigation command to change the displayed information in said viewing area to another level in said hierarchy of data entities.

11. A wearable device according to claim 10, wherein said wearable device includes an elongate display and is arranged to be carried on the user's wrist, and wherein said first sensor is an orientation sensor sensing the current rotational position of the wrist to keep the viewing area in line-of-sight of the user, whereby the processing means is adapted to dynamically create said viewing area on said elongate display by sliding said viewing area said display in response to orientation signals provided by said first sensor, and to configure areas of the display not in the current viewing area as at least one command entry area.

12. A wearable device according to claim 10, wherein said wearable device includes at least two discrete display screens on different sides of said wearable device, and wherein said first sensor is an orientation sensor sensing the current display screen being faced upward in line-of-sight of the user when carried in the hand of the user, whereby the processor is adapted to dynamically create said viewing area on said upwardly oriented display screen in response to orientation signals provided by said first sensor, and to configure display screens being on any other side as at least one command entry area.

13. A wearable device according to claim 11, wherein said first sensor includes one or more sensors selected from the group of: a gyroscope, a gravity switch, one or more accelerometers, a light sensor or a camera.

14. A wearable device according to claim 10, including a second sensor located at at least one additional area outside the display screen, wherein said processor is configured to sense and interpret at least one press by the user on said second sensor as a navigation command to alter the displayed information in said viewing area within the same level of said hierarchy of data entities.

15. A wearable device according to claim 10, including a multitude of second sensors arranged in a row on opposite sides and outside of the display screen, wherein said processor is configured to sense and interpret two simultaneous presses by the user on two selected second sensors outside and on opposite sides of the display screen as a select command to select the data entity located on a virtual line crossing the display screen between said selected sensors, and to issue a command to alter the selected data entity.

16. (canceled)

17. A non-transitory computer readable medium having stored thereon a computer program product for navigating among a multitude of displayable data entities arranged in a hierarchy, said computer program product having computer-executable program code portions for causing a processor of a computing device to cony out the steps comprising of;
defining a viewing area visible to the user on a device with touch-sensitive display for displaying information on at least one first level of said hierarchy;
sensing the position of the device with regard to the user to keep the viewing area on said touch-sensitive display visible to the user;
defining at least one area of said touch-sensitive display that is outside said viewing area as at least one command entry area; and
upon sensing at least one press by the user on said at least one command entry area, issuing a predetermined navigation command changing the displayed information in said viewing area by navigating to a second level in said hierarchy of data entities that is different from said first level.

18. A non-transitory computer readable medium according to claim 17, wherein the viewing area of the touch-sensitive display is created dynamically by sliding said viewing area along an elongate display as determined by an orientation sensor for sensing the position of the device with regard to the user and configuring at least one display area not in the current viewing area as a command entry area.

19. A non-transitory computer readable medium according to claim 17, wherein the touch-sensitive display includes at least two discrete display screens on different sides of said device, and including dynamic configuration of the display screen being on a side which is in the line of sight of the user as the current viewing area, and the display screens being on any other side as at least one command entry area.

20. A non-transitory computer readable medium according to claim 18, wherein the sensing of the position of the device to keep the viewing area in line of sight of the user is performed with the orientation sensor in said device carried on the user's wrist by sensing the current rotational position of the wrist.

21. A non-transitory computer readable medium according to claim 19, wherein the sensing of the position of the device to keep the viewing area in line of sight of the user is performed with an orientation sensor in said device carried in the hand of the user by sensing the current display screen being faced upward.

22. A non-transitory computer readable medium according to claim 1, wherein a press by the user on at least one command entry area issues a command stepping the displayed information in said viewing area to the next higher level of said hierarchy of data entities.

23. A non-transitory computer readable medium according to claim 17, wherein two simultaneous presses by the user on two different command entry areas issues an exit command taking the displayed information to the highest level of said hierarchy of data entities.

24. A non-transitory computer readable medium according to claim 17, wherein a press by the user on at least one additional area outside the display screen is sensed with at least one sensing element in order to issue a command to alter the displayed information in said viewing area within the same level of said hierarchy of data entities.

25. A non-transitory computer readable medium to claim 24, wherein two simultaneous presses by the user on two selected additional areas outside and on opposite sides of the display screen having a multitude of sensing elements issues a select command to select the data entity located on a virtual line crossing the display screen between said selected areas, and issues a command to alter the selected data entity.
